(19) United States
(12) Patent Application Publication
(10) Pub. No.: US 2015/0356051 A1
(43) Pub. Date: Dec. 10, 2015

(54) MODULARIZED COMMUNICATION DEVICE

(71) Applicant: Exosite LLC, Minneapolis, MN (US)

(72) Inventors: Mark Dennis Benson, Plymouth, MN (US); Hans Aaron Rempel, Minneapolis, MN (US)

(21) Appl. No.: 14/734,496

(22) Filed: Jun. 9, 2015

Related U.S. Application Data
(60) Provisional application No. 62/009,439, filed on Jun. 9, 2014.

(51) Int. Cl. G06F 13/42; G06F 13/40

(52) U.S. Cl. CPC G06F 13/4282; G06F 13/4095

(57) ABSTRACT

A modularized intermediate communication device for a sensor network includes multiple electronic modules assembled in a stack and configured to communicate with one another. Each of the stackable electronic modules includes a housing including first and second stacking portions mechanically complementary to each other. Each module further includes a first inter-module communication connector arranged on the first stacking portion, a second inter-module communication connector arranged on the second stacking portion, and a communication device electrically connected to the first and second inter-module communication connectors and communicating with a matching electronic module using at least one communication protocol.

### CROSS REFERENCE TO RELATED APPLICATION

This application claims priority to U.S. Application Ser. No. 62/009,439, filed on Jun. 9, 2014, entitled MODULARIZED COMMUNICATION DEVICE, the disclosure of which is hereby incorporated by reference in its entirety.

### BACKGROUND

A wireless sensor network employs multiple sensor devices arranged at desired places to monitor several parameters including physical or environmental conditions or status, such as temperature, sound and pressure. One example of the wireless sensor network is built of nodes that are connected to sensor devices. Each of such sensor network nodes typically includes several parts, such as a radio transceiver with an antenna, a microcontroller, and an energy source. The sensor devices or nodes then operate to pass their data through the network to a main location, such as a remotely located server.

### SUMMARY

In general terms, this disclosure is directed to a modularized intermediate communication device. In one possible configuration and by non-limiting example, the intermediate communication device is employed in a sensor network and includes multiple electronic modules assembled in a stack and configured to communicate therebetween. Various aspects are described in this disclosure, which include, but are not limited to, the following aspects.

One aspect is an electronic system for performing a predetermined function and communicating with a server computing device via data communication network, the system comprising: a plurality of stackable electronic modules including first and second electronic modules, each module comprising: a housing including first and second stacking portions, the first and second staking portions configured to be mechanically complementary to each other; a first inter-module communication connector arranged on the first stacking portion; a second inter-module communication connector arranged on the second stacking portion; and an electronic circuit comprising: a processing device; and a communication device electrically connected to the first and second inter-module communication connectors and configured to communicate with an electronic circuit of other electronic modules using at least one communication protocol, wherein the first inter-module communication connector of the first electronic module and the second inter-module communication connector of the second electronic module are configured to abut the first stacking portion of the first electronic module with the second stacking portion of the second electronic module when the first electronic module is stacked to the second electronic module.

Another aspect is a stackable electronic module comprising: a housing including first and second stacking portions, the first and second staking portions configured to be mechanically complementary to each other; a first inter-module communication connector arranged on the first stacking portion; a second inter-module communication connector arranged on the second stacking portion; and an electronic circuit comprising: a processing device; and a communication device electrically connected to the first and second inter-module communication connectors and configured to communicate with a matching electronic module using at least one communication protocol.

Yet another aspect is a method of performing a predetermined function and communicating with a server computing device via data communication network, the method comprising: stacking a communication module to a sensor module by engaging a first inter-module communication connector of the communication module with a second inter-module communication connector of the sensor module, the communication module configured to communicate with the server computing device via the network, and the sensor module configured to perform the predetermined function; and mounting the stack of the communication module and the sensor module to a predetermined place, wherein the first inter-module communication connector of the communication module is arranged on a first stacking portion of the communication module, and the second inter-module communication connector of the sensor module is arranged on a second stacking portion of the sensor module, and wherein the first inter-module communication connector of the communication module and the second inter-module communication connector of the sensor module are configured to abut the first stacking portion of the communication module with the second stacking portion of the sensor module when the sensor module is stacked to the communication module.

### BRIEF DESCRIPTION OF THE DRAWINGS

FIG. 1 illustrates an example embodiment of a system for operating an intermediate communication device in network environment.

FIG. 2 illustrates an exemplary architecture of a computing device that can be used to implement aspects of the present disclosure.

FIG. 3 is a perspective view of an example intermediate communication device.

FIG. 4 is a top perspective view of an example electronic module.

FIG. 5 is a bottom perspective view of the electronic module of FIG. 4.

FIG. 6 is a top plan view of the electronic module of FIG. 4.

FIG. 7 is a bottom plan view of the electronic module of FIG. 4.

FIG. 8 is an expanded view of the electronic module of FIG. 4.

FIG. 9 is another expanded view of the electronic module of FIG. 4.

FIG. 10 illustrates example end plates.

FIG. 11 is a perspective view of an example electronic circuit.

FIG. 12 is another perspective view of the electronic circuit of FIG. 11.

FIG. 13 is a perspective view of example inter-module communication connectors.

FIG. 14 is an example pin assignment of the inter-module communication connectors of FIG. 13.

FIG. 15 is a schematic diagram illustrating an example module-to-module stack connection for a communication module and a non-communication module.

FIG. 16 is an example stacking connector.

FIG. 17 is an example mounting plate.

FIG. 18 is an expanded view of the intermediate communication device of FIG. 3.

FIG. 19 illustrates another example of the inter-module communication connectors.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

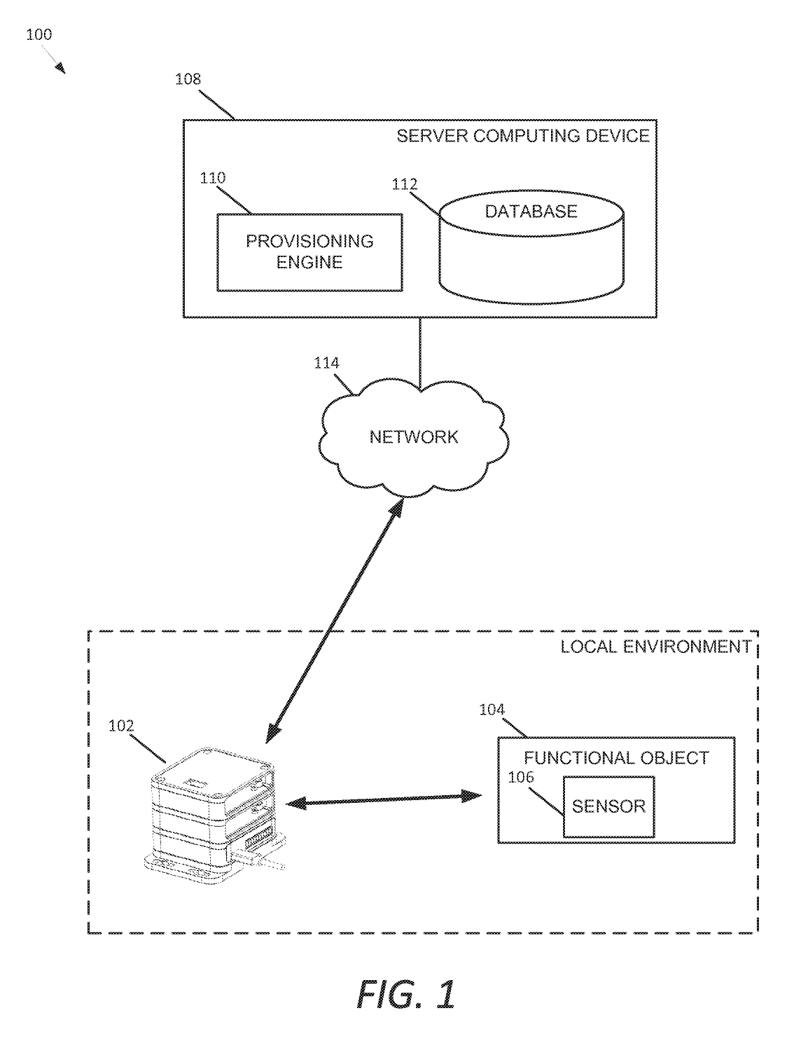

FIG. 1 illustrates an example embodiment of a system 100 for operating an intermediate communication device in network environment. In some embodiments, the system 100 includes an intermediate communication device 102, a functional object 104 including a sensor device 106, and a server computing device 108 with a provisioning engine 110 and a database 112, and a data communication network 114.

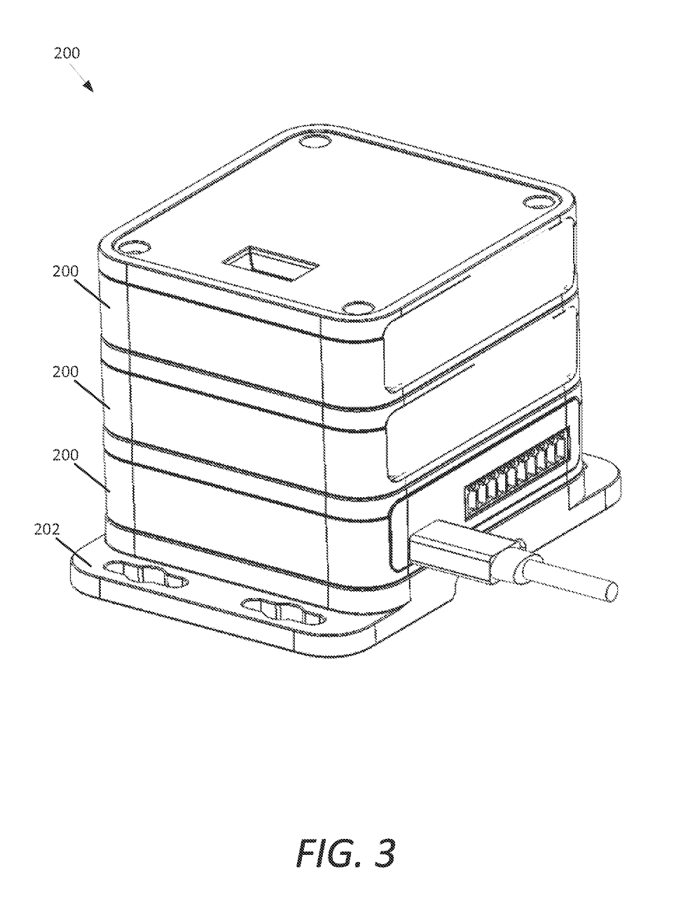

The intermediate communication device 102 operates to perform a predetermined function as well as interact with the server computing device 108 via the network 114. In some embodiments, the predetermined function of the intermediate communication device 102 includes communicating with the functional object 104 and receiving data collected by the sensor device 106 of the functional object 104. As described below, the intermediate communication device 102 is made with a configurable set of electronic modules joined together to form a stack or node in the network environment. An example of the intermediate communication device 102 is illustrated and described in more detail with reference to FIG. 3.

The functional object 104 is a device that operates to perform a predetermined function and interact with the intermediate communication device 102. In some embodiments, the functional object 104 is configured as a monitoring device. For example, one or more functional objects 104 are arranged in solar battery banks to detect the status of the batteries. In another example, the functional objects 104 are placed in an elevator system to monitor the statue of a plurality of elevators.

The sensor device 106 is, in some embodiments, included in, or attached to, the functional object 104 to observe the status of the subjects that the functional object 104 monitors. In some embodiments, when the sensor device 106 obtains monitored information or data, the functional object 104 or the sensor device 106 thereof interacts with the intermediate communication device 102 to transmit the data to the intermediate communication device 102. As described below, the intermediate communication device 102 then operates to receive the data and transmit it to the server computing device 108 via the network 114. In some embodiments, the functional object 104 communicates with the intermediate communication device 102 via a wireless communication system, a wired communication system, or a combination of wireless and wired communication systems.

The server computing device 108 operates to interact with the intermediate communication device 102. In some embodiments, the server computing device 108 includes the provisioning engine 110 and the database 112.

The provisioning engine 110 operates to identify the intermediate communication device 102 and associate the intermediate communication device 102 with an entity. The provisioning engine 110 also operates to provision resources, such as an API key, to the intermediate communication device 102.

The database 112 is a data storage device configured to store a variety of information. Examples of the database 112 include a hard disk drive, a collection of hard disk drives, digital memory (such as random access memory), a redundant array of independent disks (RAID), or other data storage devices. In some embodiments information is distributed across multiple local or remote data storage devices. The database 112 stores data in an organized manner, such as in a hierarchical or relational database structure, or in lists and other data structures such as tables. Although the database 112 is illustrated as being a component of the server computing device 108, in at least some embodiments the database 112 is separate from the server computing device 108.

The network 114 communicates digital data between one or more computing devices, such as between the intermediate communication device 102 and the server computing device 108. Examples of the network 114 include a local area network and a wide area network, such as the Internet. In some embodiments, the network 114 includes a wireless communication system, a wired communication system, or a combination of wireless and wired communication systems. A wired communication system can transmit data using electrical or optical signals in various possible embodiments. Wireless communication systems typically transmit signals via electromagnetic waves, such as in the form of optical signals or radio frequency (RF) signals. A wireless communication system typically includes an optical or RF transmitter for transmitting optical or RF signals, and an optical or RF receiver for receiving optical or RF signals. Examples of wireless communication systems include Wi-Fi communication devices (such as utilizing wireless routers or wireless access points), cellular communication devices (such as utilizing one or more cellular base stations), and other wireless communication devices.

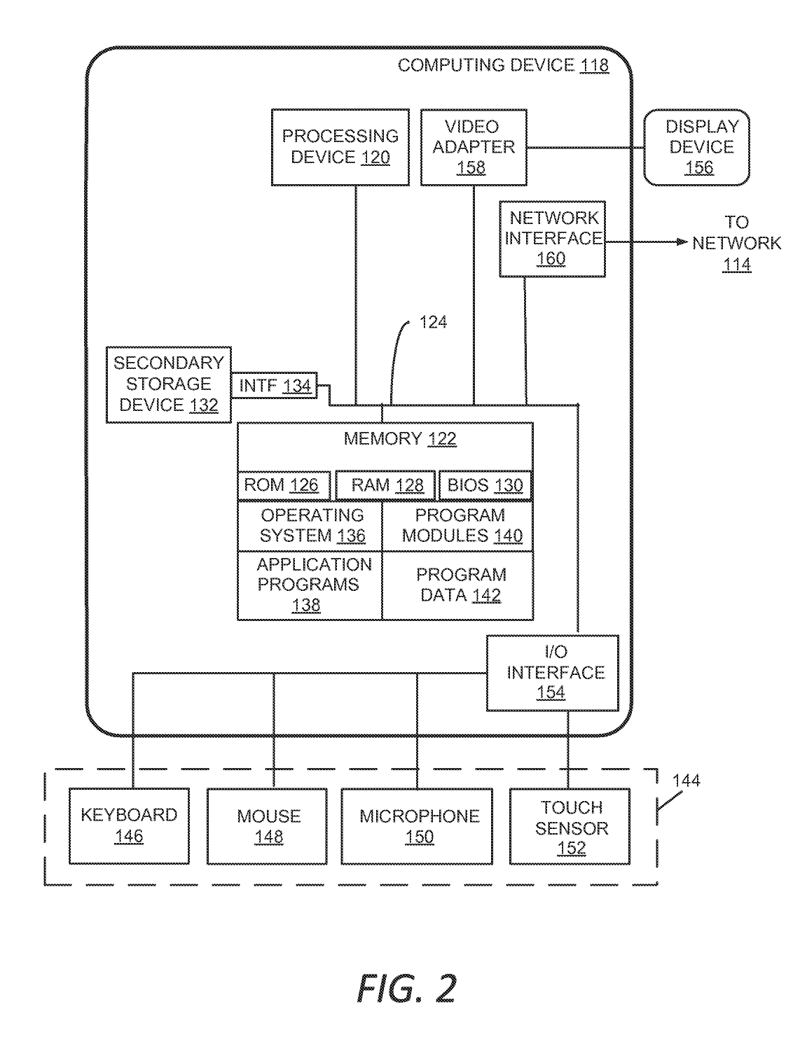

FIG. 2 illustrates an exemplary architecture of a computing device that can be used to implement aspects of the present disclosure, including the intermediate communication device 102 (including an electronic module 200 or an electronic circuit 214 thereof) and the server computing device 108, and will be referred to herein as a computing device 118. One or more computing devices, such as the type illustrated in FIG. 2, are used to execute the operating system, application programs, and software modules (including the software engines) described herein.

The computing device 118 includes, in at least some embodiments, at least one processing device 120, such as a central processing unit (CPU). A variety of processing devices are available from a variety of manufacturers, for example, Intel or Advanced Micro Devices. In this example, the computing device 118 also includes a system memory 122, and a system bus 124 that couples various system components including the system memory 122 to the processing device 120. The system bus 124 is one of any number of types of bus structures including a memory bus or memory controller, a peripheral bus, and a local bus using any of a variety of bus architectures.

Examples of computing devices suitable for the computing device 118 include a desktop computer, a laptop computer, a tablet computer, a mobile phone device such as a smart phone, or other devices configured to process digital instructions.

The system memory 122 includes read only memory 126 and random access memory 128. A basic input/output system 130 containing the basic routines that act to transfer information within computing device 118, such as during start up, is typically stored in the read only memory 126.

The computing device 118 also includes a secondary storage device 132 in some embodiments, such as a hard disk drive, for storing digital data. The secondary storage device 132 is connected to the system bus 124 by a secondary storage interface 134. The secondary storage devices and their associated computer readable media provide nonvolatile storage of computer readable instructions (including application programs and program modules), data structures, and other data for the computing device 118.

Although the exemplary environment described herein employs a hard disk drive as a secondary storage device, other types of computer readable storage media are used in other embodiments. Examples of these other types of computer readable storage media include magnetic cassettes, flash memory or other solid state memory technology, digital video disks, Bernoulli cartridges, compact disc read only memories, digital versatile disk read only memories, random access memories, or read only memories. Some embodiments include non-transitory media.

A number of program modules can be stored in a secondary storage device 132 or a memory 122, including an operating system 136, one or more application programs 138, other program modules 140, and program data 142. The data used by the computing device 118 may be stored at any location in the memory 122, such as the program data 142, or at the secondary storage device 132.

In some embodiments, computing device 118 includes input devices 144 to enable the caregiver to provide inputs to the computing device 118. Examples of input devices 144 include a keyboard 146, pointer input device 148, microphone 150, and touch sensor 152. A touch-sensitive display device is an example of a touch sensor. Other embodiments include other input devices 144. The input devices are often connected to the processing device 120 through an input/output interface 154 that is coupled to the system bus 124. These input devices 144 can be connected by any number of input/output interfaces, such as a parallel port, serial port, game port, or a universal serial bus. Wireless communication between input devices 144 and interface 154 is possible as well, and includes infrared, BLUETOOTH® wireless technology, 802.11a/b/g/n, cellular or other radio frequency communication systems in some possible embodiments.

In this example embodiment, a touch sensitive display device 156 is also connected to the system bus 124 via an interface, such as a video adapter 158. In some embodiments, the display device 156 is a touch sensitive display device. A touch sensitive display device includes sensor for receiving input from a user when the user touches the display or, in some embodiments, or gets close to touching the display. Such sensors can be capacitive sensors, pressure sensors, optical sensors, or other touch sensors. The sensors not only detect contact with the display, but also the location of the contact and movement of the contact over time. For example, a user can move a finger or stylus across the screen or near the screen to provide written inputs. The written inputs are evaluated and, in some embodiments, converted into text inputs.

In addition to the display device 156, the computing device 118 can include various other peripheral devices (not shown), such as speakers or a printer.

When used in a local area networking environment or a wide area networking environment (such as the Internet), the computing device 118 is typically connected to the network through a network interface, such as a wireless network interface 160. Other possible embodiments use other communication devices. For example, some embodiments of the computing device 118 include an Ethernet network interface, or a modem for communicating across the network.

The computing device 118 typically includes at least some form of computer-readable media. Computer readable media includes any available media that can be accessed by the computing device 118. By way of example, computer-readable media include computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 118.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

FIG. 3 is a perspective view of an example intermediate communication device 102. In some embodiments, the intermediate communication device 102 includes one or more electronic modules 200 and a mounting plate 202.

As depicted, the intermediate communication device 102 operates to perform a predetermined function, such as a monitoring function. As described above, in some embodiments, the intermediate communication device 102 is configured as a node in a sensor network. For example, the intermediate communication device 102 operates to receive sensor input, such as detected information or data, from the sensor device 106 of the functional object 104 located at a predetermined region in the sensor network. The intermediate communication device 102 then operates as a communication node by interacting with the server computing device 108 and transmitting the sensor input to the server computing device 108 via the network 114.

The electronic modules 200 are configured to be stackable to each other and constitute the intermediate communication device 102. For example, the intermediate communication device 102 is made with a set of electronic modules 200 that are selected to perform a particular function when stacked and assembled together.

Each of the electronic modules 200 is configured to have a different characteristic and function from other electronic modules 200. Thus, the function of the intermediate communication device 102 is configurable by selecting a desired combination of electronic modules 200. Examples of the electronic modules 200 include a communication module (which is also referred to as a gateway module), a power supply module, and an application-specific module. In some embodiments, the communication module is configured to interact with the server computing device 108 via the network 114. In some embodiments, the intermediate communication device 102 needs only one communication module in the stack. The power supply module is configured to supply power to other electronic modules electrically connected thereto. The application-specific module operates to perform a predetermined function in the relevant application. In some embodiments, the application-specific module is configured as an I/O device or module. For example, when the application-specific module is configured to communicate with the sensor device 106 of the functional object 104, the application-specific module interacts with the functional object 104 and receives sensor data monitored by the sensor device 106 from the functional object 104. In this case, the application-specific module can be referred to as a sensor module. The application-specific module can be configured as a cellular module or a Wi-Fi module to establish data communication with the functional object 104. Other than the examples described above, the electronic modules 200 can be of any type.

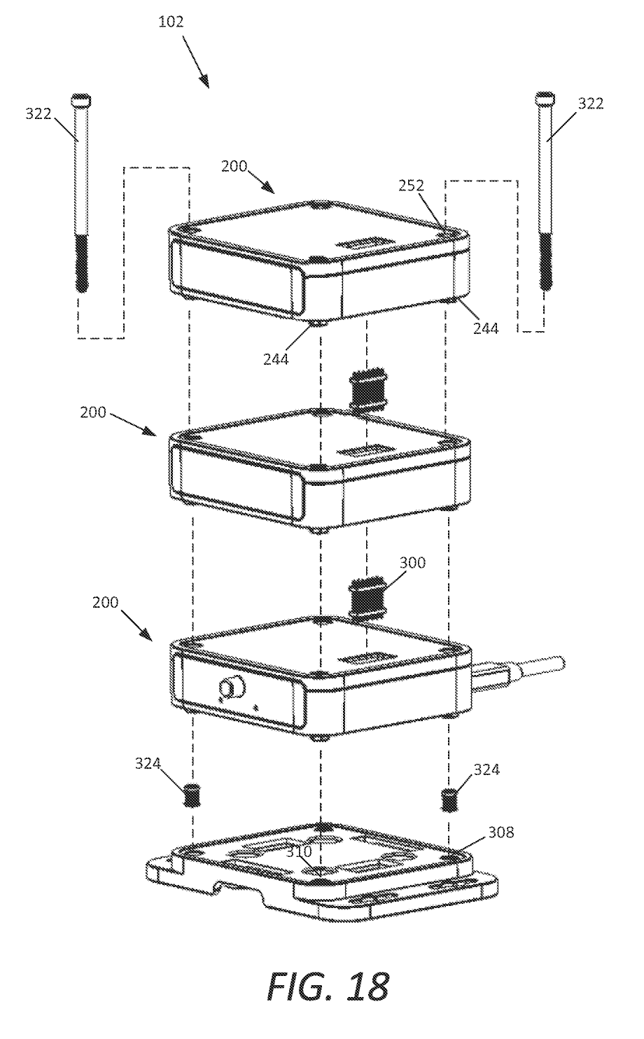

The electronic modules 200 are configured to communicate with each other when stacked and assembled together. For example, when the communication module, the power supply module, and the I/O module are stacked and assembled together, the modules are electrically connected to one another, either directly or indirectly, so that data communication is allowed among the assembled electronic modules 200. An example stacking of a plurality of electronic modules 200 is described and illustrated in more detail with reference to FIG. 18.

In some embodiments, each of the electronic modules 200 is configured to be independently certifiable by relevant authorities. For example, in the United States, each electronic module 200 is certified under Federal Communications Commission (FCC) rules and regulations, such as Code of Federal Regulations, Telecommunications, Title 47, Part 15, on electromagnetic interference from electronic products. In the Europe, each electronic module 200 is certified under CE rules and regulations, which correspond to FCC rules and regulations in the U.S. On the other hand, each electronic module 200 is so configured that, once the electronic module 200 is certified under law, the assembly or combination of a plurality of the certified electronic modules 200 does not require recertification by the authorities. The configurations and features of the electronic module 200 as described below are configured to avoid recertification for the stack of electronic modules 200 when assembled together.

As such, users or manufacturers can configure the nature or feature of the intermediate communication device 102 as desired by selecting particular types of electronic modules 200 and assembling them together. The users or manufacturers then can label the assembled electronic modules 200 as a single device without obtaining certification for the assembled device again.

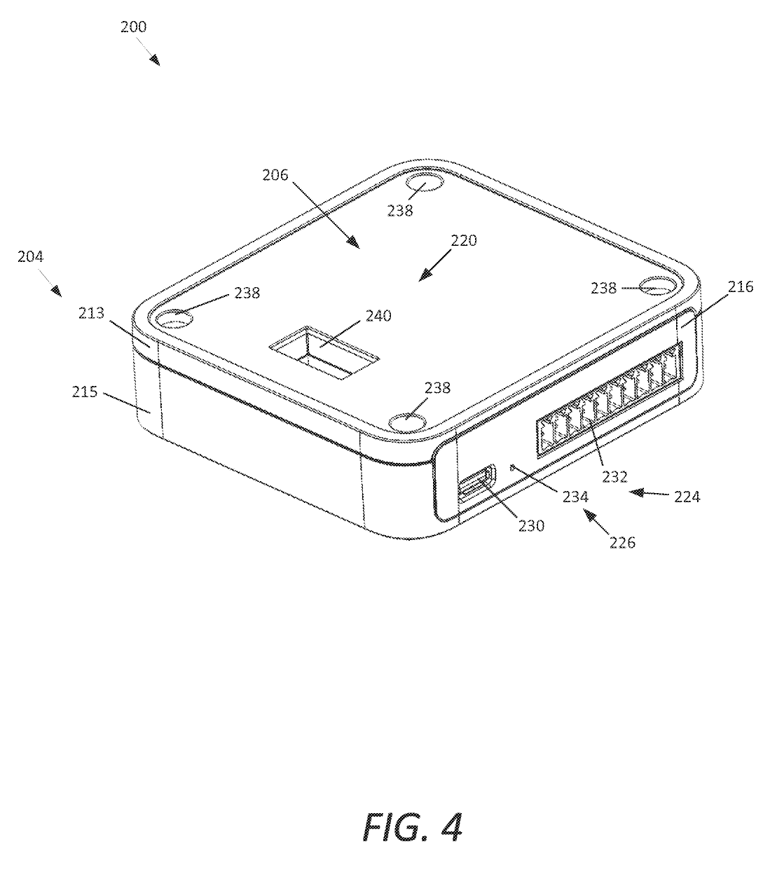

The electronic modules 200 have several common features, configurations, and connections while there are other features, configurations, and connections specific to different types of electronic modules 200. An example of the electronic module 200 is illustrated and described in more detail with reference to FIGS. 4-9.

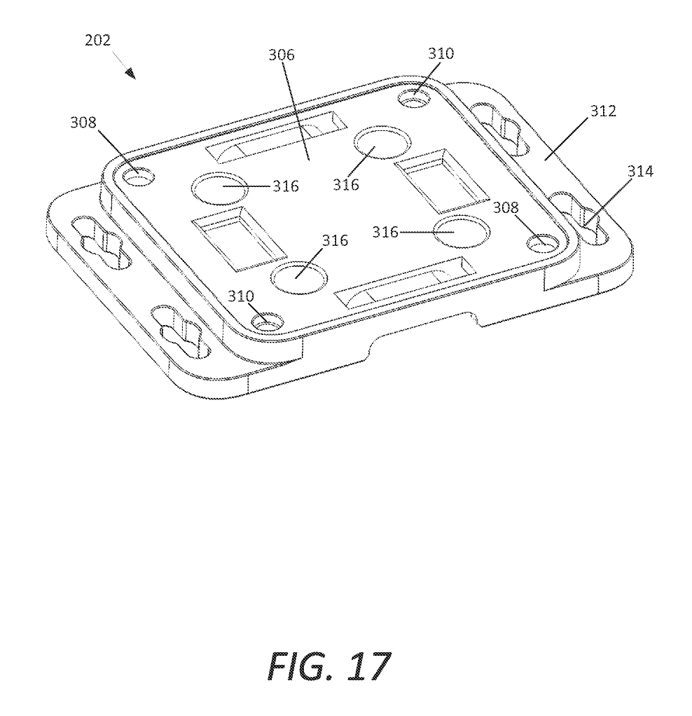

The mounting plate 202 operates to mount the intermediate communication device 102 to a predetermined place at which the intermediate communication device 102 performs a desired function, such as monitoring with the functional object 104. For example, the mounting plate 202 is configured to engage one or more electronic modules 200 and be fixed to the predetermined place. An example of the mounting plate 202 is illustrated and described in more detail with reference to FIG. 17.

FIGS. 4-9 illustrate an example electronic module 200. In general, the electronic module 200 includes a housing 204 having a first stacking portion 206 and a second stacking portion 208, a first inter-module communication connector 210, a second inter-module communication connector 212, and an electronic circuit 214. Each element of the electronic module 200 is described and illustrated hereinafter.

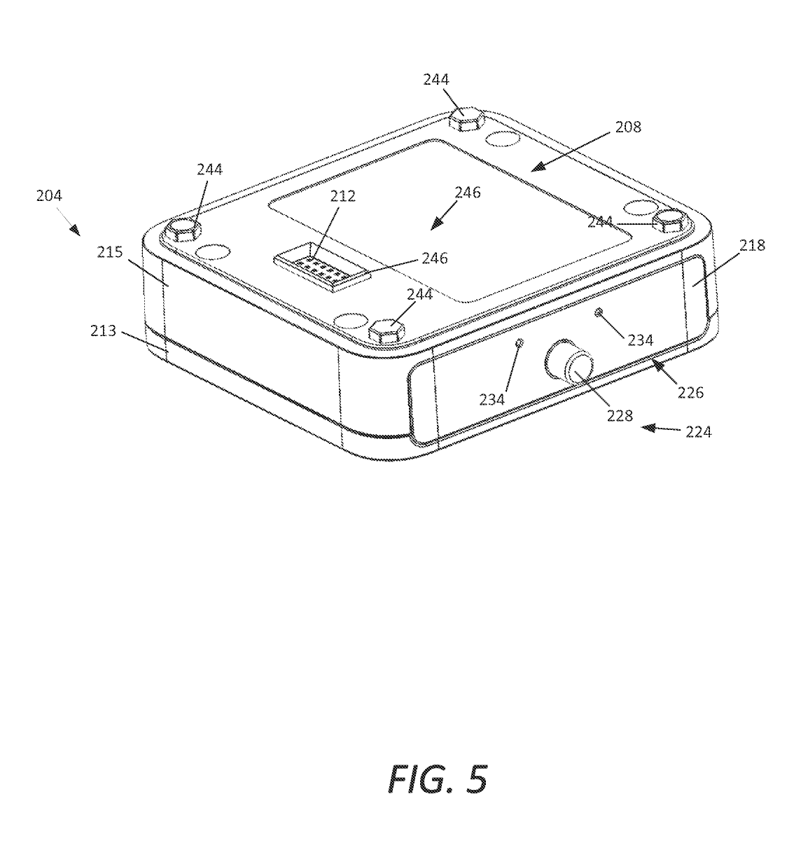

FIG. 4 is a top perspective view of an example electronic module 200. As described above, in some embodiments, the electronic module 200 includes the housing 204 with the first stacking portion 206 and the second stacking portion 208. In some embodiments, the housing 204 includes a first body portion 213, a second body portion 215, a first end plate 216, and a second end plate 218 (FIG. 5). The first stacking portion 206 includes a first engagement mechanism 220, and the second stacking portion 208 includes a second engagement mechanism 222 (FIG. 5).

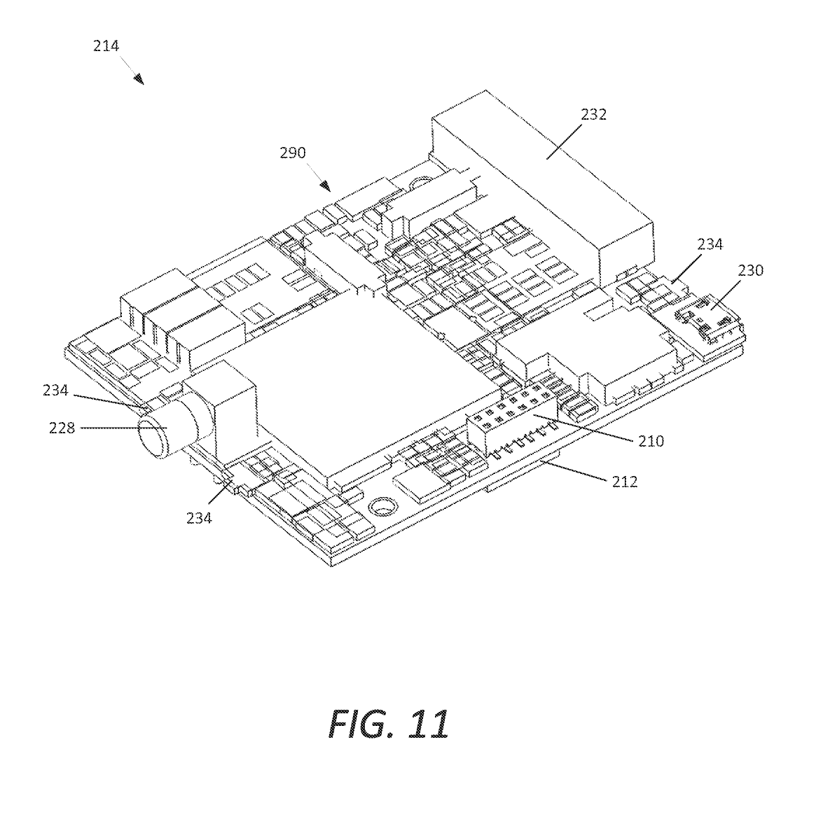

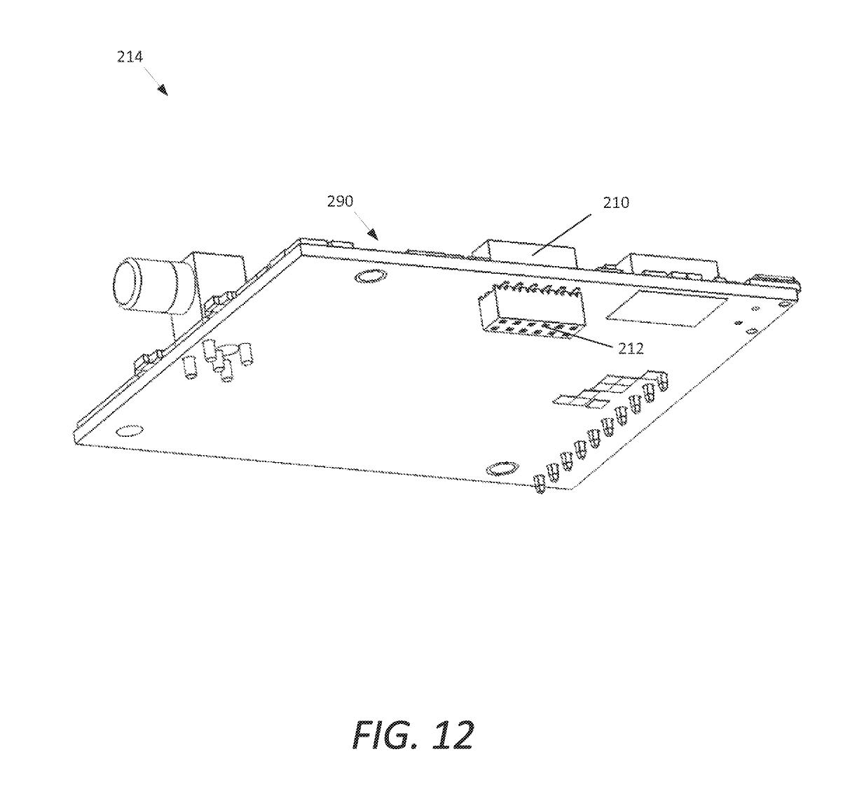

The housing 204 is configured to define a hollow for receiving the electronic circuit 214 (FIGS. 11 and 12) therein.

The first and second stacking portions 206 and 208 are configured to be mechanically complementary to each other. In particular, the first stacking portion 206 of the electronic module 200 is configured to complementarily engage a second stacking portion 208 of another electronic module 200. As depicted, in some embodiments, the first and second stacking portions 206 and 208 are configured substantially as the surfaces of the first and second body portions 213 and 215.

The first and second body portions 213 and 215 are configured as part of the housing 204, respectively. For example, the first and second body portions 213 and 215 are assembled to form the housing 204 except for the first and second end plates 216 and 218. As described above, in some embodiments, the first and second body portions 213 and 215 include the first and second stacking portions 206 and 208, respectively.

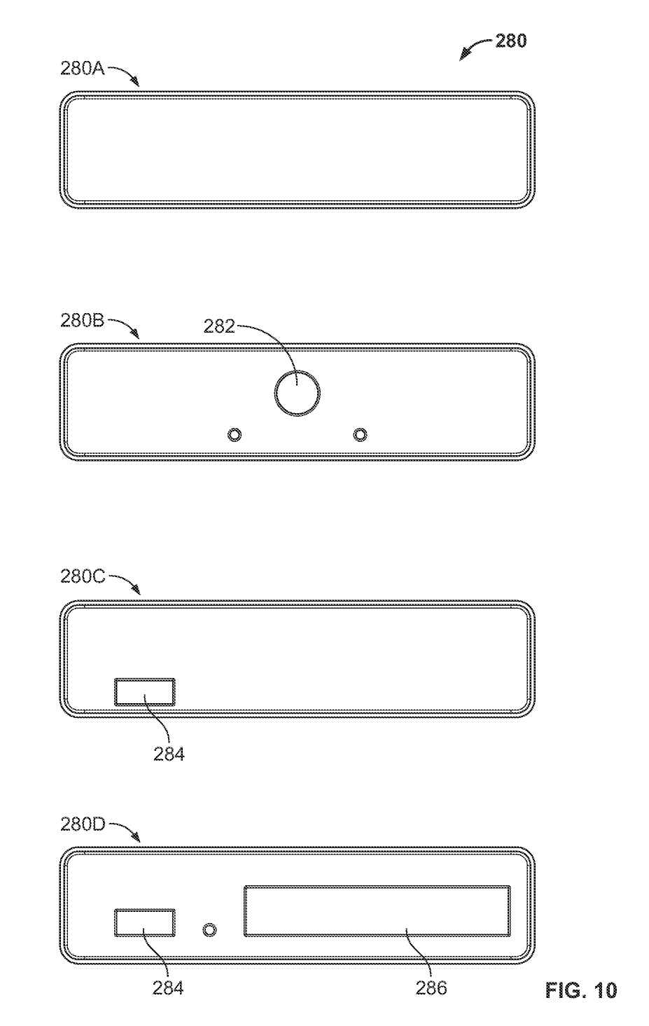

The first and second end plates 216 and 218 are arranged on the opposite sides of the housing 204 and configured to arrange one or more input devices or connectors 224 and other functional elements 226. The end plates 216 and 218 are configured to be replaceable with different types of end plates. Examples of the connectors 224 include coaxial RF connectors 228 (FIG. 5), USB connectors 230, and terminal blocks 232. Examples of the functional elements 226 include LED indicators 234. Examples of the end plates 216 and 218 are illustrated and described in more detail with reference to FIG. 10.

The first engagement mechanism 220 operates to engage the electronic module 200 with another electronic module 200. For example, the first engagement mechanism 220 of the electronic module 200 is configured to be mechanically complementary to a second engagement mechanism 222 of the other electronic module 200 so that the first engagement mechanism 220 of the electronic module 200 engages the second engagement mechanism 222 of the other electronic module 200. As depicted, in some embodiments, the first engagement mechanism 220 is formed on the first stacking portion 206.

Similarly to the first engagement mechanism 220, the second engagement mechanism 222 operates to engage the electronic module 200 with another electronic module 200. For example, the second engagement mechanism 222 of the electronic module 200 is configured to be mechanically complementary to a first engagement mechanism 220 of the other electronic module 200 so that the second engagement mechanism 222 of the electronic module 200 engages the first engagement mechanism 220 of the other electronic module 200. An example of the second engagement mechanism 222 is illustrated and described with reference to FIG. 5.

In some embodiments, the first engagement mechanism 220 of the first stacking portion 206 includes stacking recesses 238 and a first connector recess 240.

The stacking recesses 238 are configured to mate stacking projections 244 of the second engagement mechanism 222, as illustrated below. In some embodiments, the stacking recesses 238 are formed at or around corners of the surface of the first body portion 213. However, the stacking recesses 238 can be arranged anywhere on the first stacking portion 206 or the first body portion 213.

The first connector recess 240 is also configured to assist the engagement and/or alignment of the first stacking portion 206 of the electronic module 200 with a second stacking portion 208 of another electronic module 200. As shown below, the first connector recess 240 is also configured to arrange a first inter-module communication connector 210.

FIG. 5 is a bottom perspective view of the electronic module 200 of FIG. 4, illustrating the second engagement mechanism 222 of the second stacking portion 208. In some embodiments, the second engagement mechanism 222 includes stacking projections 244 and a second connector projection 246.

The stacking projections 244 of the second stacking portion 208 are configured to engage the stacking recesses 238 of the first stacking portion 206, as shown above. In the depicted example, the stacking projections 244 are arranged at or around corners of the surface of the second body portion 215 so as to match the stacking recesses 238 of the first body portion 213 when two electronic modules 200 are stacked and assembled together.

The second connector projection 246 is configured to further assist the engagement and/or alignment of the second stacking portion 208 of the electronic module 200 with a first stacking portion 206 of another electronic module 200. As shown below, the second connector projection 246 is also configured to arrange a second inter-module communication connector 212.

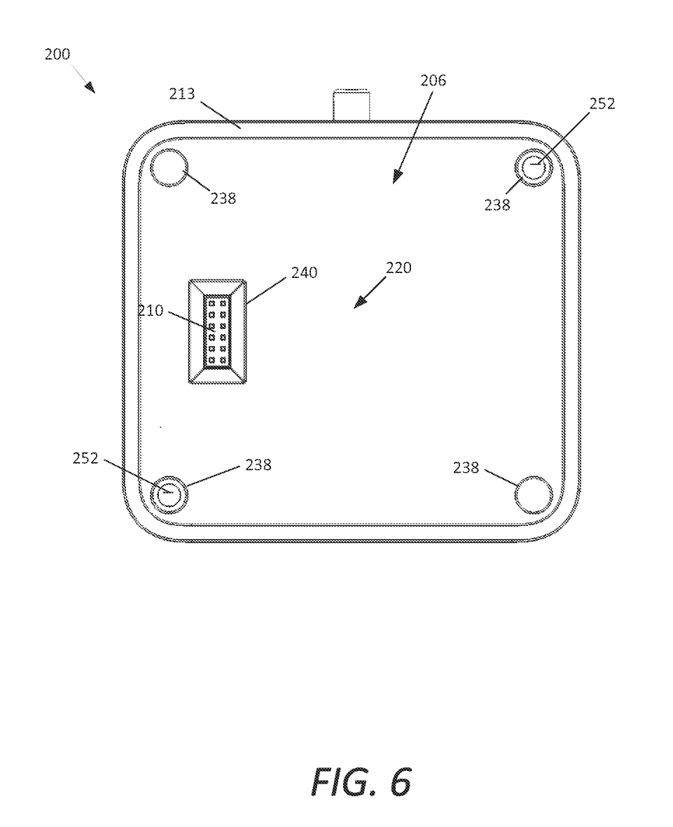

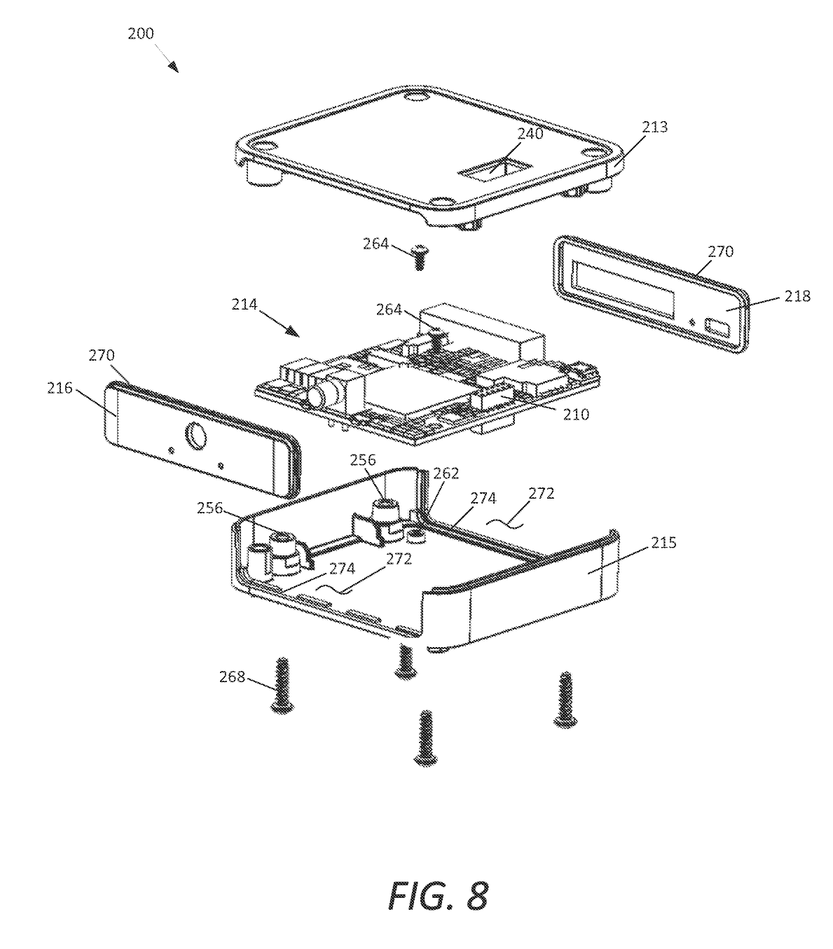

FIG. 6 is a top plan view of the electronic module 200 of FIG. 4, illustrating the first stacking portion 206. In some embodiments, the electronic module 200 includes one or more assembly through-holes 252. The first connector recess 240 arranges and receives a first inter-module communication connector 210 (See also FIG. 8).

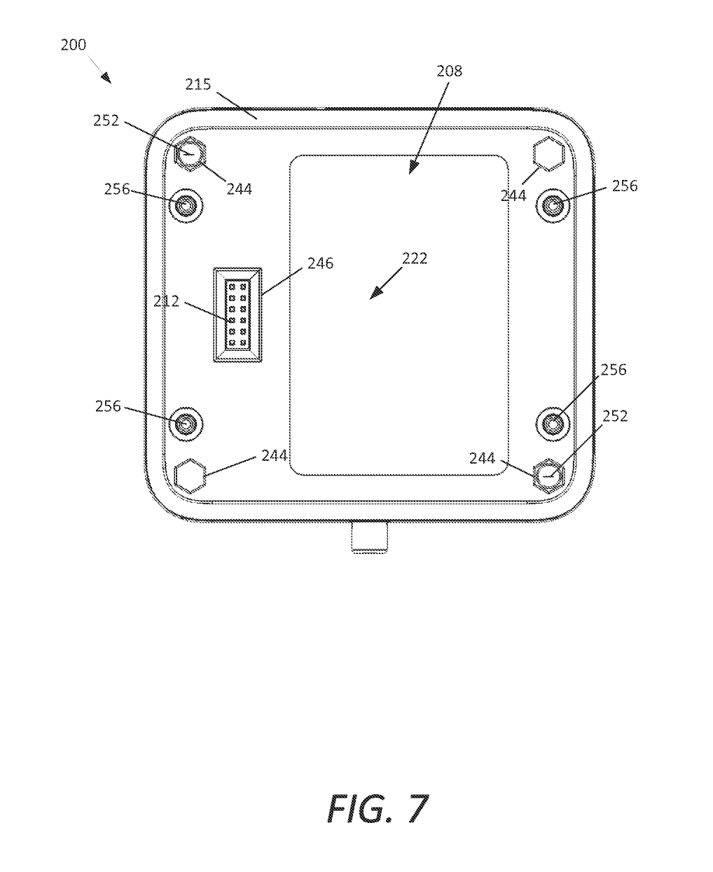

The assembly through-hole 252 is configured to receive a device fastener 322 (FIG. 18) to assemble a plurality of stacked electronic modules 200 and/or the mounting plate 202. In some embodiments, the assembly through-hole 252 is formed through at least some of the stacking recesses 238 and the corresponding stacking projections 244 of the second stacking portion 208 (FIG. 7). In the depicted example, the assembly through-hole 252 is formed along two of the stacking recesses 238 of the first stacking portion 206.

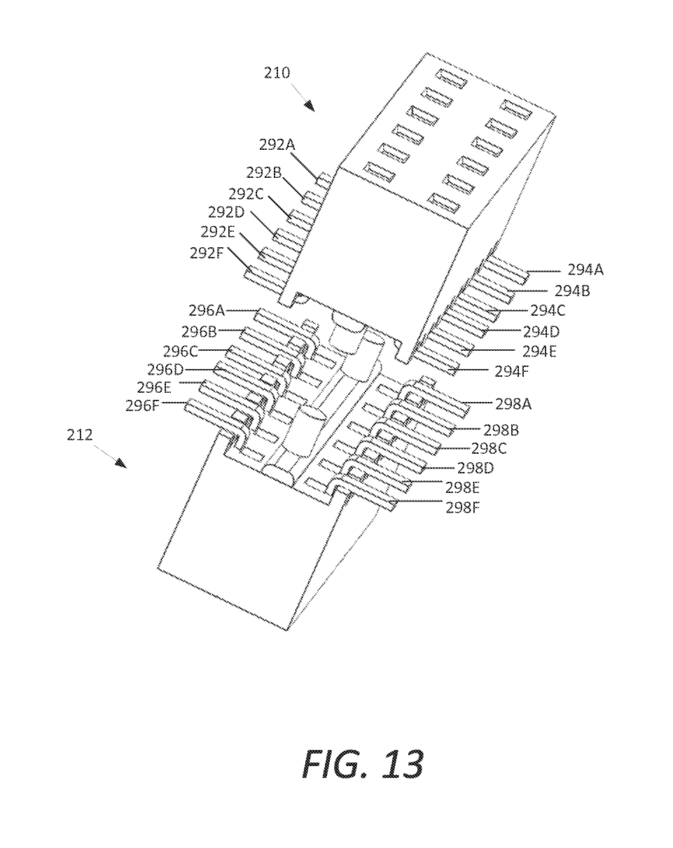

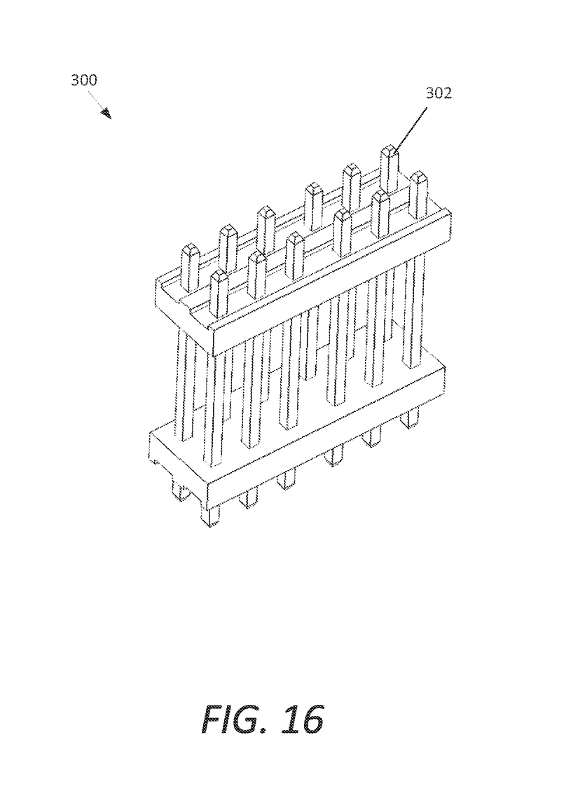

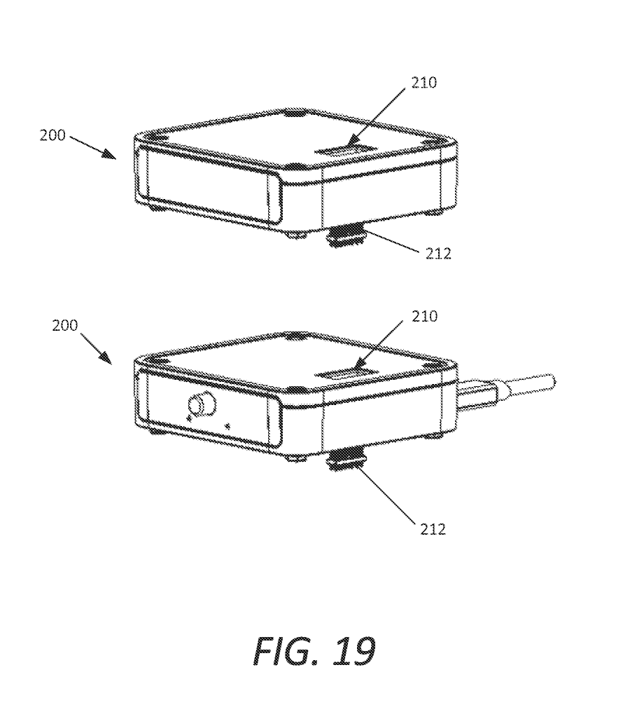

The first inter-module communication connector 210 is a connector configured to electrically connect electronic circuits 214 of stacked electronic modules 200. As shown below, in some embodiments, the first and second inter-module communication connectors 210 and 212 are configured as female sockets or ports (FIG. 13), and the first inter-module communication connector 210 is electrically connected to the electronic circuit 214 of the electronic module 200 and electrically connected to a second inter-module communication connector 212 of another electronic module 200 through a stacking connector 300 (FIG. 16). In other embodiments, the first and second inter-module communication connectors 210 and 212 are configured to be directly connected to each other without such an intermediate connector as the stacking connector 300, when adjacent electronic modules 200 are stacked and assembled together. For example, one of the first and second inter-module communication connectors 210 and 212 is configured as a female socket or the like, and the other is configured as a corresponding male plug or the like that is directly engaged with the female socket (FIG. 19).

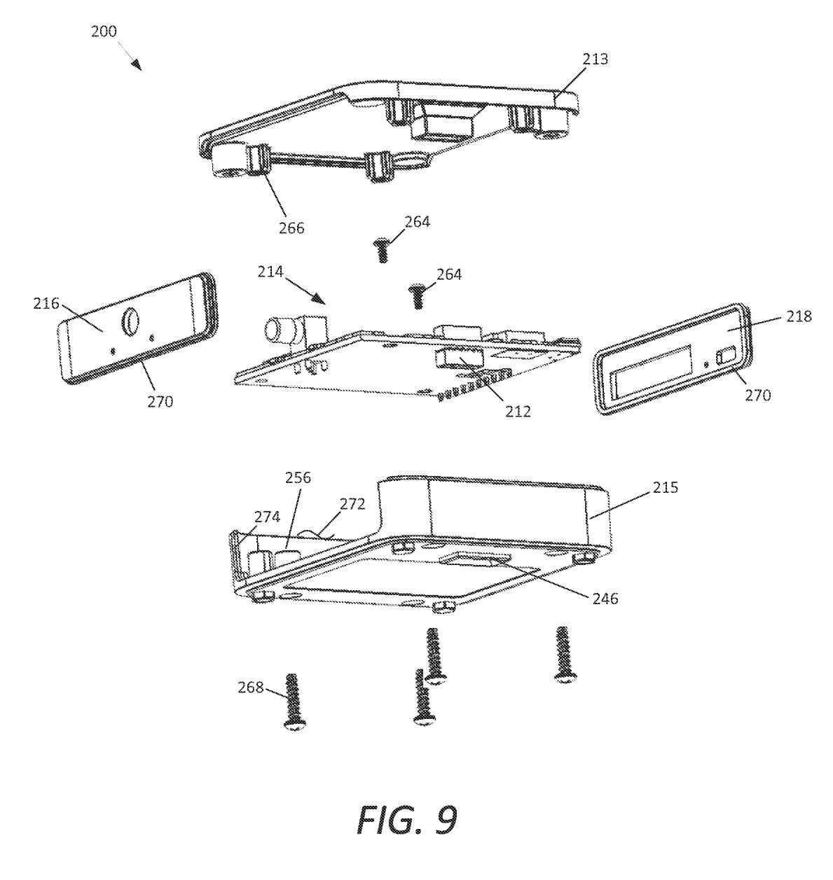

FIG. 7 is a bottom plan view of the electronic module 200 of FIG. 4, illustrating the second stacking portion 208. As described in FIG. 6, the electronic module 200 includes the through-holes 252. In some embodiments, the electronic module 200 includes one or more module assembly holes 256. The second connector projection 246 arranges and receives a second inter-module communication connector 212 (See also FIG. 9).

As described, the through-holes 252 is formed through at least some of the stacking projections 244, as well as the corresponding stacking recesses 238 of the first stacking portion 206.

The module assembly holes 256 are configured to receive a module fastener 268 (FIG. 8), such as a screw, to assemble the first and second body portions 213 and 215. In some embodiments, while the module assembly holes 256 are formed from the second body portion 215, the first body portion 213 includes corresponding nut portions 266 (FIG. 9) formed inside the first body portion 213 so that the module fasteners 268 are inserted into the module assembly holes 256 and screwed into the nut portions.

The second inter-module communication connector 212 is a connector configured to electrically connect electronic circuits 214 of stacked electronic modules 200. In some embodiments, the second inter-module communication connector 212 is connected to the electronic circuit 214 opposite to the first inter-module communication connector 210, as shown in FIG. 11. Thus, the second inter-module communication connector 212 is electrically connected to the electronic circuit 214 of the electronic module 200 and electrically connected to a first inter-module communication connector 210 of another electronic module 200, either directly or through the stacking connector 300 (FIG. 16).

As such, the first and second stacking portions 206 and 208 are configured to be abutted to each other by engaging the first and second engagement mechanisms 220 and 222 when the associated electronic modules 200 are stacked together. As described below, the stacking connector 300 is also configured to allow the first and second stacking portions 206 and 208 to be engaged or abutted to each other when the modules 200 are assembled in a stack.

FIGS. 8 and 9 are expanded views of the electronic module 200 of FIG. 4, illustrating the assembly of the electronic module 200.

In the depicted example, the electronic circuit 214 is mounted to the bottom of the second body portion 215. For example, the second body portion 215 includes circuit nut portions 262 on the bottom surface thereof, and the electronic circuit 214 is fixed to the second body portion 215 by screwing circuit fasteners 264 into the circuit nut portions 262.

The first body portion 213 is coupled onto the second body portion 215 when the electronic circuit 214 is mounted onto the second body portion 215 as described above. In some embodiments, the second body portion 215 includes the module assembly holes 256, as illustrated above, and the first body portion 213 includes module nut portions 266 on the inside surface thereof that correspond to the module assembly holes 256 of the second body portion 215. Thus, the first body portion 213 is fixed to the second body portion 215 by inserting the module fasteners 268 into the module assembly holes 256 and engaging the module fasteners 268 with the module nut portions 266.

In some embodiments, the first and second end plates 216 and 218 include engaging projections 270 formed on the periphery of the first and second end plates 216 and 218, respectively. Correspondingly, the first and second body portions 213 and 215 include end plate openings 272, which are defined when the first and second body portions 213 and 215 are assembled, and engaging grooves 274 formed on at least a portion of edges of the first and second body portions 213 and 215 around the end plate openings 272. The end plate openings 272 are shaped substantially the same as the outline of the end plates 216 and 218 so as to receive the end plates 216 and 218 therein. Therefore, the first and second end plates 216 and 218 are coupled to the first and second body portions 213 and 215 by engaging the engaging projections 270 of the end plates 216 and 218 with the engaging grooves 274 of the body portions 213 and 215. In particular, the end plates 216 and 218 are placed to a portion of the end plate openings 272 of the second body portion 215 by inserting the engaging projections 270 into the engaging grooves 274 of the second body portion 215. Then, the first body portion 213 is assembled onto the second body portion 215 so that the engaging grooves 274 of the first body portion 213 receive the engaging projections 270 of the end plates 216 and 218.

FIG. 10 illustrates example end plates 216 and 218, which are collectively designated as reference number 280. The end plate 280 is configured to meet the configuration of the electronic module 200 that varies depending on the function of the electronic module 200. For example, the end plate 280 is modified to accommodate different types of connectors.

An end plate 280A is configured as a sold plate with no holes. The end plate 280A is used to close the end plate opening 272 of the housing 204 when there is no connector or indicator used on that side of the housing 204.

An end plate 280B has a hole 282 configured to receive a coaxial RF connector 228 connected to, and extending from, the electronic circuit 214. An example of the coaxial RF connector is a SMA connector.

An end plate 280C has a hole 284 configured to receive a USB connector 230 connected to, and extending from, the electronic circuit 214. Examples of the USB connector 230 include micro-USBs and mini-USBs.

An end plate 280D further includes a hole 286 configured to receive a terminal block 232 connected to, and extending from, the electronic circuit 214.

In some embodiments, the end plate 280 is also configured to arrange the functional elements 226. For example, the end plate 280 includes one or more holes for receiving the LED indicators 234 (FIGS. 4 and 5). In other embodiments, the end plate 280 includes transparent windows through which light from the LED indicators 234 passes.

Although, in the depicted example, the electronic module 200 includes two end plates 216 and 218, the electronic module 200 can be configured to include just one end plate or more than two end plates as necessary.

FIGS. 11 and 12 illustrate an example electronic circuit 214. In some embodiments, the electronic circuit 214 includes a printed circuit board (PCB) 290 onto which a communication device 291 is electrically connected. Further, as described above, the coaxial RF connector 228, the USB connector 230, the terminal block 232, and the LED indicators 234 are electrically connected onto the PCB 290. Also, the electronic circuit 214 includes the first and second inter-module communication connectors 210 and 212 electrically connected to the PCB 290.

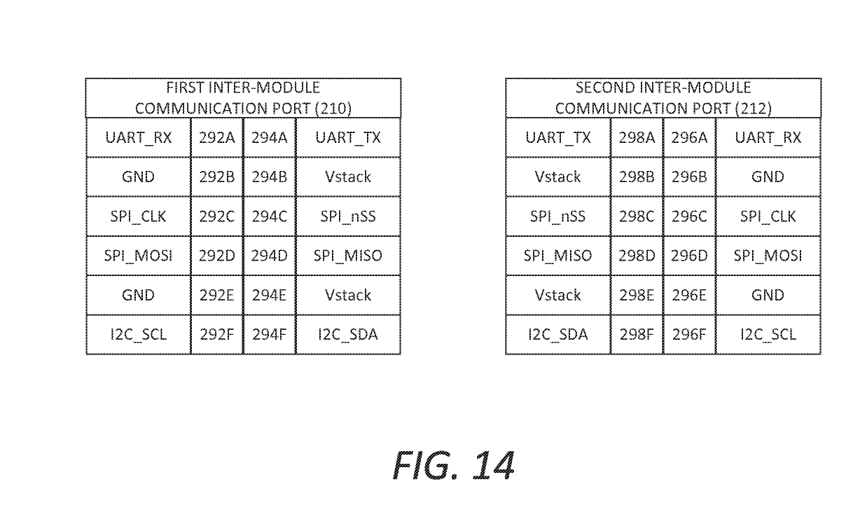

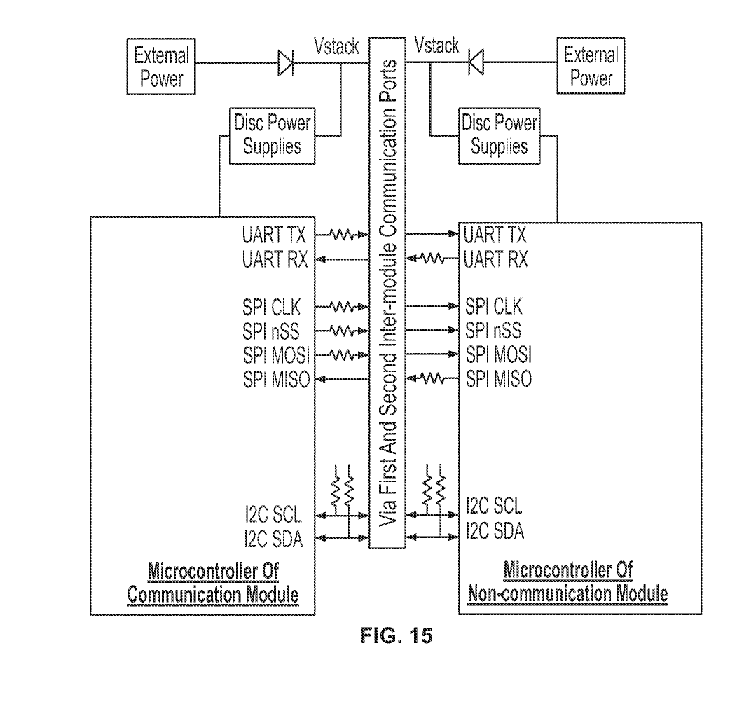

The communication device 291 is electrically connected to the first and second inter-module communication connectors 210 and 212 and configured to communicate with an electronic circuit 214 of another electronic module 200 that is stacked and assembled with the subject electronic module 200. In some embodiments, the communication device 291 is configured as a microcontroller that provides an electrical interface for serial communication to adjacent modules 200 through the connectors 210 and 212. The communication device 291 uses one or more communication protocol, such as I²C, SPI, and UART. An example communication between the connected electronic modules 200 is illustrated and described with reference to FIGS. 14 and 15.

In some embodiments, the coaxial RF connector 228 is electrically connected onto the PCB 290, and extends from the housing 204 through the hole 282. Examples of the coaxial RF connector 228 include SMA connectors and RP-SMA connectors, such as part numbers CONSMA002 and CONREVSMA002, which distributed by Linx Technologies, Merline, Oreg. In other embodiments, any other coaxial RF connectors are used. The PCB 290 and the housing 204 can be designed to have as many coaxial RF connectors. In some embodiments, the PCB 290 and the housing 204 are designed to have up to three coaxial RF connectors. In some embodiments, the electronic module 200 employs RF modules with internal antennas, instead of using external antennas with the coaxial RF connectors.

In some embodiments, the USB connector 230 is electrically connected onto the PCB 290 for power supply and communication, such as support for debug, firmware update, and external USB devices. Examples of the USB connector 230 include a micro-USB connector, such as part number Molex 47589-0001 distributed by Molex Co., Lisle, Ill.

In some embodiments, the terminal block 232 is electrically connected onto the PCB 290. In some embodiments, the terminal block 232 is a pluggable terminal block including a terminal block header, such as part number Molex 39502-1010, with a terminal block plug, such as part number Molex 039500-0010, distributed by Molex Co., Lisle, Ill.

In some embodiments, the LED indicators 234 are electrically connected onto the PCB 290 to indicate the power and operating status of the module 200. The LED indicators 234 can also be used to indicate communication status. In some embodiments, the LED indicator 234 is a bi-color status LED. An example of the LED indicator 234 is part number LTST-S326KGJRKT distributed by Lite-On Co., Taipei, Taiwan.

The first and second inter-module communication connectors 210 and 212 are configured to allow the assembled electronic modules 200 to share power and communications with each other therethrough. In some embodiments, the first and second inter-module communication connectors 210 and 212 are mounted onto the opposite sides of the PCB 290 so that the first and second inter-module communication connectors 210 and 212 are mounted directly opposite to each other with the PCB 290 arranged therebetween. An example of the inter-module communication connectors 210 and 212 is illustrated and described in more detail with reference to FIGS. 13 and 14.

The electronic circuit 214 includes other necessary elements (e.g., the processing device 120 and the memory 122) selected from at least part of the components of the computing device 118 as illustrated in FIG. 2. Further, the electronic circuit 214 can include other elements required for performing predetermined functions of the electronic circuit 214.

FIG. 13 is a perspective view of example inter-module communication connectors 210 and 212. As described, the inter-module communication connectors 210 and 212 are electrically connected to the communication device 291 on the PCB 290 and configured to permit data communication between stacked electronic modules 200.

In some embodiments, the inter-module communication connectors 210 and 212 are surface mount female sockets with 2×6 positions. In the depicted example, the two connectors 210 and 212 are identical and arranged symmetrically with respect to the PCB 290. Examples of the inter-module communication connector 210 or 212 include part number MMS-106-02-L-DV distributed by Samtec Inc., and part number NPPN062FFKS-RC distributed by Sullins Connector Solutions, San Marcos, Calif. As depicted, the inter-module communication connectors 210 and 212 have 12 pins (292A-F and 294A-F; and 296A-F and 298A-F) respectively. An example pin assignment of the inter-module communication connector 210 or 212 is illustrated and described with reference to FIG. 14.

As described below in more detail, a stacking connector 300 (FIG. 16) is used to connect the first inter-module communication connector 210 of one electronic module 200 to the second inter-module communication connector 212 of another electronic module 200.

FIG. 14 is an example pin assignment of the first and second inter-module communication connectors 210 and 212 for several signals. In the depicted example, the signal pins of the first and second inter-module communication connectors 210 and 212 are symmetrically arranged with respect to the PCB 290 so that signals route straight between the first inter-module communication connector 210 and the second inter-module communication connector 212 when the two electronic modules 200 are stacked and assembled together.

Referring to FIG. 14, Vstack represents DC power shared between the stacked electronic modules 200. GND indicates a DC ground. I2C_SCL means an I²C clock signal. I2C_SDA means an I²C data signal. SPI_CLK represents a SPI clock signal that is output from a master device (e.g., the communication module). SPI_MOSI indicates a signal output from the master device (“SPI Master Output, Slave Input”). SPI_MISO indicates a signal input to the master device (“SPI Master Input, Slave Output”). SPI_nCS indicates a signal of SPI Chip Select (active low) output from the master device. UART_TX is a UART Transmit signal output from the master device (e.g., the communication module), and UART_RX is a UART Receive signal input to the master device. In some embodiments, the master device is the communication module among the stacked electronic modules 200 of the intermediate communication device 102. The signal names described above are entitled from the perspective of the communication module.

In some embodiments, Vstack is configured to range between about 4.3 V (min) and about 5.5 V (max). Vstack is typically 5.0 V. The maximum current rating (Istack) available to all electronic modules 200 in the intermediate communication device 102 is about 2.0 A while the current flowing through each pin does not exceed 1.0 A.

In some embodiments, all of the signals are 3.3 V CMOS IO signals. The low level voltage for input signal (V_{IL}) does not exceed about 0.3*3.3 V. The high level voltage for input signal (V_{IH}) is not lower than about 0.7*3.3 V. The low level voltage for output signal (V_{OL}) does not exceed about 0.3*3.3 V. The high level voltage for output signal (V_{OH}) is not lower than about 0.7*3.3 V.

The power module, which is an electronic module 200 that powers the intermediate communication device 102, is configured to tolerate being back-powered on the same pins in the first and second inter-module communication connectors 210 and 212. In some embodiments, a Schottky diode is used for this purpose. The power module is configured to regulate its external power source as needed to provide Vstack voltage as described above at the Vstack pins. Any additional voltages required by the module are configured to be regulated from Vstack. This configuration allows the module to function properly whether it is powered from its own external connection or from the stack connectors.

In some embodiments, the electronic modules 200 implementing I²C are configured to support I²C speeds up to 400 kHz. The electronic modules 200 are configured to support multi-master I²C operation. Any electronic module that includes more than one I²C device is configured to use an I²C buffer to isolate additional loads on the same electronic module from the stack I²C bus. An example of such an I²C buffer is part number PCA9511 distributed by NXP Semiconductors, Eindhoven, Netherlands. The signals I2C_SCL and I2C_SDA are configured to be pulled up to 3.3 V by 10 k ohm resistors in any electronic module that uses I²C communication. This configuration results in the following effective pull-up strengths within a stack: two electronic modules −5 k ohm, three modules −3.3 k ohm, and four modules −2.5 k ohm.

In some embodiments, all of the electronic modules 200 stacked in the intermediate communication device 102 are configured to implement I²C communication.

The communication module, such as a cellular, Wi-Fi, or Ethernet module, is configured to use UART communication. In some embodiments, UART communication can be used in other types of electronic modules 200. In some embodiments, all of the electronic modules 200 are configured to pass through the UART signals regardless of whether or not the UART signals are used by those modules 200.

The directions of UART signals are relative to the communication module. UART_TX is an output on the communication module and an input on any other types of electronic modules 200. In some embodiments, UART outputs on any electronic module include series resistors in-line to protect from any damage in the case of signal contention. Where multiple electronic modules 200 share UART communications, a stack is configured to be assembled such that only one UART-based electronic module is connected to the communication module at a time.

The communication module, such as a cellular, Wi-Fi, or Ethernet module, is configured to use SPI communication. In some embodiments, SPI communication can be used in other types of electronic modules 200. In some embodiments, all of the electronic modules 200 are configured to pass through the SPI signals regardless of whether or not the SPI signals are used by those modules 200.

In some embodiments, the communication module is configured to always function as the SPI master. In this case, a signal SPI_MOSI is an output on the communication module and an input on any other types of electronic modules 200. In some embodiments, SPI outputs on any electronic module include series resistors in-line to protect from any damage in the case of signal contention.

In some embodiments, an electronic module 200 is configured to only respond to SPI traffic when nSS is low. In some embodiments, where multiple electronic modules 200 share SPI, software is configured to arbitrate via I²C first to decide which electronic module is using SPI at any given time or a stack is configured to be assembled such that only one SPI is connected at a time.

FIG. 15 is a schematic diagram illustrating an example module-to-module stack connection for a communication module and a non-communication module.

FIG. 16 is an example stacking connector 300. The stacking connector 300 is configured to be coupled to the first and second inter-module communication connectors 210 and 212. When two electronic modules 200 are stacked and assembled together, the stacking connector 300 is engaged between the first inter-module communication connector 210 of one electronic module 200 and the second inter-module communication connector 212 of the other electronic module 200. In this case, the first stacking portion 206 of the one electronic module 200 is engaged or abutted with the second stacking portion 208 of the other electronic module 200.

In the depicted example, the stacking connector 300 includes pins 302 complementary to the sockets of the first and second inter-module communication connectors 210 and 212, and thus the stacking connector 300 is engaged with the connectors 210 and 212 by inserting the pins 302 into the sockets thereof. The stacking connector 300 is not configured to be soldered to the PCB 290. Examples of the stacking connector 300 include part number TW-06-07-G-D-410-160 distributed Samtec, Inc., and part number Molex 0877610008 distributed by Molex Co., Lisle, Ill.

FIG. 17 is an example mounting plate 202. In some embodiments, the mounting plate 202 includes a supporting surface 306 including one or more device nut holders 308 and stacking projection receptacles 310, and one or more mounting flanges 312 including one or more mounting holes 314.

The mounting plate 202 is configured to install the intermediate communication device 102 to a predetermined place. In particular, the mounting plate 202 engages one or more electronic modules 200 and is configured to be fixed to a predetermined place.

The supporting surface 306 is configured to engage the second stacking portion 208 of the electronic module 200 that is mounted onto the mounting plate 202.

The device nut holders 308 formed on the supporting surface 306 are aligned with the stacking projections 244 that include the assembly through-hole 252. The device nut holder 308 is configured to receive and hold a device nut 324 (FIG. 18) configured to engage the tip of the device fastener 322 (FIG. 18). In some embodiments, the device nut holder 308 is also configured to receive the corresponding stacking projections 244 of the second stacking portion 208 of the electronic module 200.

The stacking projection receptacles 310 formed on the supporting surface 306 are aligned with the stacking projections 244 that do not include the assembly through-hole 252. The stacking projection receptacle 310 is configured to receive the corresponding stacking projection 244 of the second stacking portion 208 of the electronic module 200.

The mounting flanges 312 are configured to be placed onto a predetermined place at which the intermediate communication device 102 is installed.

The mounting holes 314 of the mounting flanges 312 are configured to receive installing devices (not shown), such as fasteners and nylon cable ties, and allow the installing devices to secure the mounting plate 202 onto the predetermined place.

In some embodiments, the mounting plate 202 further includes mounting holes 316 formed from the supporting surface 306. Similarly to the mounting holes 314, the mounting holes 316 are configured to receive the installing devices to secure the mounting plate 202 onto the predetermined place.

FIG. 18 is an expanded view of an example intermediate communication device 102. One or more electronic modules 200 are stacked and assembled together with the stacking connector 300 engaged therebetween, and mounted onto the mounting plate 202, by one or more device fasteners 322 through the assembly through-holes 252. The device fasteners 322 are fastened into device nuts 324 that are secured within the device nut holders 308 of the mounting plate 202.

For example, the stacking connector 300 is inserted into a first inter-module communication connector 210 of a first electronic module 200, and then a second electronic module 200 is stacked onto the first electronic module 200 so that a second inter-module communication connector 212 of the second electronic module 200 engages the stacking connector 300 that has been inserted into the first inter-module communication connector 210 of the first electronic module 200. In some embodiments, the device fasteners 332 are used to assemble the first and second electronic modules 200. The stacking connector 300 is configured to permit a first stacking portion 206 of the first electronic module 200 to engage a second stacking portion 208 of the second electronic module 200. Once the two electronic modules 200 are stacked and assembled, the stack of the modules 200 is mounted to a desired place. In some embodiments, the stack of the modules 200 is installed to the place through the mounting plate 202. The stack of the modules 200 is coupled onto the mounting plate 202 by inserting the device fasteners 322 through the assembly through-holes 252 and screwing it into the device nuts 324 that are fixed to the mounting plate 202. Then, the mounting plate 202 is installed to the desired place by fasteners or tie cables.

Although only two electronic modules 200 are described in assembling process above, more than two electronic modules 200 can be stacked and assembled together in a similar manner. Further, the assembling steps illustrated above can change as necessary. As described above, the electronic modules 200 that are stacked together include the communication module (or the gateway module), the I/O module (or the sensor module), and the power source module.

In some embodiments, the electronic module 200 includes one or more labels provided on the housing 204. The labels can be customized as necessary for each application. In some embodiments, the labels are provided for product branding purposes, such as product name and/or logo. The labels can also be provided for product information, such as model number and/or serial number information. In some embodiments, the labels for product information are attached on the side surface of the housing 204 so that the labels remain visible even if multiple electronic modules 200 are assembled in a stack. The labels can also be provided for regulatory information and any other additional product information.

FIG. 19 illustrates another example of the inter-module communication connectors 210 and 212. As depicted, in some embodiments, the electronic modules 200 has the first inter-module communication connector 210 that is configured as a female socket, and the second inter-module communication connector 212 that is configured as a male plug. The male plug of the second inter-module communication connector 212 has pins complementarily engaged with the female socket of the first inter-module communication connector 210. In this configuration, the electronic modules 200 can be directly stacked to each other without the stacking connector 300 or the like.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. An electronic system for performing a predetermined function and communicating with a server computing device via data communication network, the system comprising:
a plurality of stackable electronic modules including first and second electronic modules, each module comprising:
a housing including first and second stacking portions, the first and second staking portions configured to be mechanically complementary to each other;
a first inter-module communication connector arranged on the first stacking portion;
a second inter-module communication connector arranged on the second stacking portion; and
an electronic circuit comprising:
a processing device; and
a communication device electrically connected to the first and second inter-module communication connectors and configured to communicate with an electronic circuit of other electronic modules using at least one communication protocol,
wherein the first inter-module communication connector of the first electronic module and the second inter-module communication connector of the second electronic module are configured to abut the first stacking portion of the first electronic module with the second stacking portion of the second electronic module when the first electronic module is stacked to the second electronic module.

2. The system of claim 1, further comprising at least one stacking connector configured to be coupled to the first and second inter-module communication connectors,
wherein the stacking connector is engaged between the first inter-module communication connector of the first electronic module and the second inter-module communication connector of the second electronic module, and configured to abut the first stacking portion of the first electronic module with the second stacking portion of the second electronic module, when the first electronic module is stacked to the second electronic module.

3. The system of claim 1, wherein the first electronic module is a communication module configured to communicate with the server computing device via data communication network.

4. The system of claim 3, wherein the second electronic module is a sensor module configured to perform the predetermined function.

5. The system of claim 1, wherein the plurality of stackable electronic modules includes a communication module, a power module, and an I/O module.

6. The system of claim 1, wherein the predetermined function is configurable by stacking different electronic modules.

7. The system of claim 1, further comprising a mounting plate configured to engage one or more of the plurality of electronic modules and to be fixed to a predetermined place.

8. The system of claim 1, wherein each of the plurality of electronic modules is certifiable by relevant authorities, and
wherein the plurality of electronic modules is configured not to require recertification by the relevant authorizes when stacked.

9. The system of claim 1, wherein the housing includes at least one endplate replaceable to accommodate different input devices.

10. The system of claim 9, wherein the input devices include coaxial RF connectors, USB connectors, and terminal blocks.

11. The system of claim 1, wherein each of the plurality of electronic modules includes at least one label configured to indicate information about the electronic module.

12. The system of claim 1, wherein the at least one communication protocol is selected from I²C, SPI, and UART.

13. A stackable electronic module comprising:
a housing including first and second stacking portions, the first and second staking portions configured to be mechanically complementary to each other;
a first inter-module communication connector arranged on the first stacking portion;
a second inter-module communication connector arranged on the second stacking portion; and
an electronic circuit comprising:
a processing device; and
a communication device electrically connected to the first and second inter-module communication connectors and configured to communicate with a matching electronic module using at least one communication protocol.

14. The module of claim 13, wherein the housing includes at least one endplate replaceable to accommodate different input devices.

15. The system of claim 14, wherein the input devices include coaxial RF connectors, USB connectors, and terminal blocks.

16. The system of claim 13, wherein the at least one communication protocol is selected from I²C, SPI, and UART.

17. The system of claim 13, wherein the first stacking portion includes a plurality of projections extending therefrom, and
wherein the second stacking portion includes a plurality of recesses complementary to the plurality of projections of the first stacking portion.

18. A method of performing a predetermined function and communicating with a server computing device via data communication network, the method comprising:
stacking a communication module to a sensor module by engaging a first inter-module communication connector of the communication module with a second inter-module communication connector of the sensor module, the communication module configured to communicate with the server computing device via the network, and the sensor module configured to perform the predetermined function; and
mounting the stack of the communication module and the sensor module to a predetermined place,
wherein the first inter-module communication connector of the communication module is arranged on a first stacking portion of the communication module, and the second inter-module communication connector of the sensor module is arranged on a second stacking portion of the sensor module, and
wherein the first inter-module communication connector of the communication module and the second inter-module communication connector of the sensor module are configured to abut the first stacking portion of the communication module with the second stacking portion of the sensor module when the sensor module is stacked to the communication module.

19. The method of claim 18, further comprising:
engaging a stacking connector between the first inter-module communication connector of the communication module and the second inter-module communication connector of the sensor module,
wherein the stacking connector is configured to abut the first stacking portion of the communication module with the second stacking portion of the sensor module when the sensor module is stacked to the communication module.

20. The method of claim 18, wherein mounting the stack of the communication module and the sensor module to a predetermined place comprises:
securing the stack of the communication module and the sensor module to a mounting plate; and
installing the mounting plate to the predetermined place.

21. The method of claim 18, wherein the communication module communicates with the sensor module using at least one communication protocol.

22. The method of claim 21, wherein the at least one communication protocol is selected from I²C, SPI, and UART.
